(19) United States
(12) Patent Application Publication
(10) Pub. No.: US 2026/0107316 A1
(43) Pub. Date: Apr. 16, 2026

(54) INFORMATION REPORTING METHOD AND APPARATUS

(71) Applicant: Beijing Xiaomi Mobile Software Co., Ltd., Beijing (CN)

(72) Inventor: Xiaowei JIANG, Beijing (CN)

(21) Appl. No.: 19/113,792

(22) PCT Filed: Sep. 23, 2022
(86) PCT No.: PCT/CN2022/121042

§ 371 Date: Mar. 20, 2025

(51) Int. Cl. H04W 74/0833; H04W 36/00; H04W 74/0808

(52) U.S. Cl. CPC H04W 74/0833; H04W 36/0058; H04W 74/0808

(57) ABSTRACT

An information reporting method is performed by a terminal device and includes: reporting, in response to sending a random access (RA) preamble by using a RA resource associated with a reference signal, RA attempt related information on the reference signal to a network-side device, wherein the reference signal includes a synchronization signal block (SSB) or a channel state information reference signal (CSI-RS).

### CROSS-REFERENCE TO RELATED APPLICATIONS

This application is the U.S. national phase of PCT Application No. PCT/CN2022/121042 filed on Sep. 23, 2022, the disclosure of which is incorporated herein by reference in its entirety.

### TECHNICAL FIELD

The present disclosure relates to the field of communication technologies, and in particular, to information reporting methods and apparatuses.

### BACKGROUND

In a New Radio Unlicense (NR-U) system, whether a terminal device can successfully send a random access (RA) preamble depends on whether the terminal device can successfully perform listen-before-talk (LBT).

In the related art, a terminal device does not support reporting, to a network-side device, RA attempt related information on a reference signal (for example, a synchronization signal block (SSB) or a channel state information reference signal (CSI-RS)), in response to sending a RA preamble by using a RA resource associated with the reference signal, which is an urgent problem to be solved.

### SUMMARY

According to a first aspect, an embodiment of the present disclosure provides an information reporting method, where the method is performed by a terminal device, and the method includes: reporting, in response to sending a random access (RA) preamble by using a RA resource associated with a reference signal, RA attempt related information on the reference signal to a network-side device, wherein the reference signal comprises a synchronization signal block (SSB) or a channel state information reference signal (CSI-RS).

According to a second aspect, an embodiment of the present disclosure provides another information reporting method, where the method is performed by a network-side device, and the method includes: receiving RA attempt related information on a reference signal reported by a terminal device, where the RA attempt related information on the reference signal is reported by the terminal device when sending a preamble by using a RA resource associated with the reference signal, and the reference signal comprises a synchronization signal block, SSB, or a channel state information reference signal, CSI-RS.

According to a third aspect, an embodiment of the present disclosure provides a communication apparatus, where the communication apparatus includes a processor and a memory storing a computer program executable by the processor, wherein the processor is configured to: report, in response to sending a random access (RA) preamble by using a RA resource associated with a reference signal, RA attempt related information on the reference signal to a network-side device, wherein the reference signal comprises a synchronization signal block (SSB) or a channel state information reference signal (CSI-RS); or the processor is configured to: receive RA attempt related information on a reference signal reported by a terminal device, wherein the RA attempt related information on the reference signal is reported by the terminal device when sending a preamble by using a RA resource associated with the reference signal, and the reference signal comprises a SSB, or a CSI-RS.

### BRIEF DESCRIPTION OF DRAWINGS

The accompanying drawings of the present disclosure will be described below.

FIG. 1 is an architecture diagram of a communication system according to embodiments of the present disclosure.

FIG. 2 is a flowchart of an information reporting method according to an embodiment of the present disclosure.

FIG. 3 is a flowchart of an information reporting method according to another embodiment of the present disclosure.

FIG. 4 is a flowchart of an information reporting method according to yet another embodiment of the present disclosure.

FIG. 5 is a flowchart of an information reporting method according to yet another embodiment of the present disclosure.

FIG. 6 is a flowchart of an information reporting method according to yet another embodiment of the present disclosure.

FIG. 7 is a flowchart of an information reporting method according to yet another embodiment of the present disclosure.

FIG. 8 is a flowchart of an information reporting method according to yet another embodiment of the present disclosure.

FIG. 9 is a flowchart of an information reporting method according to yet another embodiment of the present disclosure.

FIG. 10 is a structural diagram of a communication apparatus according to an embodiment of the present disclosure.

FIG. 11 is a structural diagram of a communication apparatus according to another embodiment of the present disclosure.

FIG. 12 is a schematic structural diagram of a chip according to embodiments of the present disclosure.

### DETAILED DESCRIPTION

To better understand the information reporting methods and apparatuses disclosed in the embodiments of the present disclosure, a communication system to which the embodiments of the present disclosure are applicable will be first described below.

Embodiments of the present disclosure provide information reporting methods and apparatuses, where a terminal device supports reporting, to a network-side device, RA attempt related information on a reference signal, in response to sending a RA preamble by using a RA resource associated with the reference signal.

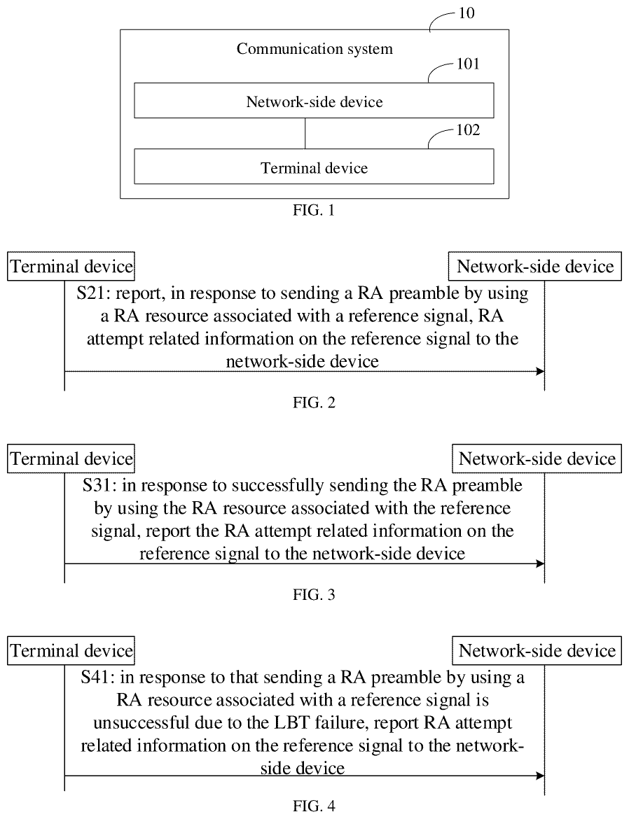

Referring to FIG. 1, FIG. 1 is a schematic architecture diagram of a communication system according to embodiments of the present disclosure. The communication system may include, but is not limited to, a network-side device and a terminal device. The number and form of devices shown in FIG. 1 are for illustrative purpose only and are not intended to constitute a limitation on the embodiments of the present disclosure. In practical applications, the communication system may include two or more network-side devices and two or more terminal devices. As an example, the communication system 10 shown in FIG. 1 may include one network-side device 101 and one terminal device 102.

It should be noted that the technical solutions in the embodiments of the present disclosure may be applied to various communication systems, for example, a long term evolution (LTE) system, a 5th generation (5G) mobile communication system, a 5G new radio (NR) system, or other new mobile communication systems in the future.

The network-side device 101 in the embodiments of the present disclosure is an entity on the network side for transmitting or receiving signals. For example, the network-side device 101 may be an evolved NodeB (eNB), a transmission reception point (TRP), a next generation NodeB (gNB) in an NR system, a base station in another mobile communication system in the future, an access node in a wireless fidelity (WiFi) system, or the like. Specific technologies and specific device forms adopted by the base station are not limited in the embodiments of the present disclosure. The base station provided in the embodiments of the present disclosure may include a central unit (CU) and a distributed unit (DU). The CU may also be referred to as control unit. A CU-DU architecture may be used to split apart the base station, for example, protocol layers of the base station. Functions of some protocol layers are placed in the CU for centralized control, and functions of some or all of the remaining protocol layers are distributed in the DU, and the DU is centrally controlled by the CU.

The terminal device 102 in the embodiments of the present disclosure is an entity on the user side for receiving or transmitting signals, for example, a mobile phone. The terminal device may also be referred to as terminal, user equipment (UE), mobile station (MS), mobile terminal (MT), or the like. The terminal device may be an automobile with a communication function, a smart automobile, a mobile phone, a wearable device, a Pad, a computer with a wireless transceiver function, a virtual reality (VR) terminal device, an augmented reality (AR) terminal device, a wireless terminal device in industrial control, a wireless terminal device in self-driving, a wireless terminal device in remote medical surgery, a wireless terminal device in a smart grid, a wireless terminal device in transportation safety, a wireless terminal device in a smart city, a wireless terminal device in a smart home, or the like. Specific technologies and specific device forms adopted by the terminal device are not limited in the embodiments of the present disclosure.

It may be understood that the communication system described in the embodiments of the present disclosure is intended to describe the technical solutions of the embodiments of the present disclosure more clearly, and is not intended to constitute a limitation on the technical solutions provided in the embodiments of the present disclosure. It is known to those skilled in the art that, with evolution of system architectures and emergence of new business scenarios, the technical solutions provided by the embodiments of the present disclosure are also applicable to similar technical problems.

In addition, for ease of understanding of the embodiments of the present disclosure, the following explanations are made.

Firstly, in the embodiments of the present disclosure, “for indicating” may include a direct indication and an indirect indication. Describing that certain information is used for indicating A may include that the information directly indicates A or indirectly indicates A, but does not necessarily mean that the information carries A.

Information indicated by the information is referred to as to-be-indicated information. In a specific implementation process, there are many manners for indicating the to-be-indicated information, for example, without limitation, the to-be-indicated information may be directly indicated, for example, the to-be-indicated information itself, an index of the to-be-indicated information, or the like. The to-be-indicated information may also be indirectly indicated by indicating other information, where there is an association relationship between the other information and the to-be-indicated information. Also, only a part of the to-be-indicated information may be indicated, and other parts of the to-be-indicated information are known or agreed on in advance. For example, specific information may also be indicated by means of a pre-agreed (for example, specified in a protocol) arrangement order of respective information, thereby reducing indication overheads to some extent.

The to-be-indicated information may be sent together as a whole, or may be divided into a plurality of pieces of sub-information to be sent separately, and sending periods and/or sending occasions of the pieces of sub-information may be the same or different. The specific sending method is not limited in the present disclosure. The sending periods and/or sending occasions of the sub-information may be predefined, for example, according to a protocol.

Secondly, the embodiments of the present disclosure illustrate a plurality of implementations to clearly describe the technical solutions of the embodiments of the present disclosure. However, those skilled in the art may understand that the plurality of implementations provided by the embodiments of the present disclosure may be executed individually, or may be executed in combination with methods of other embodiments in the embodiments of the present disclosure. Also, the plurality of implementations provided by the embodiments of the present disclosure may be executed individually together with some methods in other related technologies, or may be executed together with some methods in other related technologies after combined with methods of other embodiments in the embodiments of the present disclosure. Specific execution manners are not limited by the embodiments of the present disclosure.

In the embodiments of the present disclosure, the terminal device may store a connection establishment failure report in the case of the connection establishment failure or connection recovery failure. And the terminal device may notify the network-side device of the available connection establishment failure report through a message for connection establishment completion/connection recovery completion/connection reestablishment completion/connection reconfiguration completion the next time the terminal device accesses the network-side device. The network-side device may request the connection establishment failure report through a request message for terminal device information, and the terminal device carries the connection establishment failure report through a response message for the terminal device information. Release 17 (R-17) introduces support for the terminal device to record a plurality of reports for connection establishment failures. The connection establishment failure report contains contents as follows:

| ConnEstFailReport-r16 ::= | SEQUENCE { | |
|---|---|---|
| measResultFailedCell-r16 | MeasResultFailedCell-r16, | |
| locationInfo-r16 | LocationInfo-r16 | OPTIONAL, |

| | |
|---|---|
| measResultNeighCells-r16 | SEQUENCE { |

| | |
|---|---|
| measResultNeighCellListNR | MeasResultList2NR-r16 |

OPTIONAL,

| | |
|---|---|
| measResultNeighCellListEUTRA | MeasResultList2EUTRA-r16 |

OPTIONAL
},

| | |
|---|---|
| numberOfConnFail-r16 | INTEGER (1..8), |
| perRAInfoList-r16 | PerRAInfoList-r16, |
| timeSinceFailure-r16 | TimeSinceFailure-r16, |

```
    ...
  }
  ConnEstFailReportList-r17 ::= SEQUENCE (SIZE (1..maxCEFReport-r17)) OF ConnEstFailReport-
r16
```

The per RA information list perRAInfoList-r16 field is mandatory to carry. The perRAInfoList-r16 field has a format as follows:

PerRAInfoList-r16 ::= SEQUENCE (SIZE (1..200)) OF PerRAInfo-r16
PerRAInfoList-v1660 ::= SEQUENCE (SIZE (1..200)) OF PerRACSI-RSInfo-v1660

| | |
|---|---|
| PerRAInfo-r16 ::= | CHOICE { |
| perRASSBInfoList-r16 | PerRASSBInfo-r16, |
| perRACSI-RSInfoList-r16 | PerRACSI-RSInfo-r16 |

}

| | |
|---|---|
| PerRASSBInfo-r16 ::= | SEQUENCE { |
| ssb-Index-r16 | SSB-Index, |
| numberOfPreamblesSentOnSSB-r16 | INTEGER (1..200), |
| perRAAttemptInfoList-r16 | PerRAAttemptInfoList-r16 |

}

| | |
|---|---|
| PerRACSI-RSInfo-r16 ::= | SEQUENCE { |
| csi-RS-Index-r16 | CSI-RS-Index, |
| numberOfPreamblesSentOnCSI-RS-r16 | INTEGER (1..200) |

}

| | |
|---|---|
| PerRACSI-RSInfo-v1660 ::= | SEQUENCE { |
| csi-RS-Index-v1660 | INTEGER (1..96) OPTIONAL |

}

For each synchronization signal block (SSB), if the terminal device sends a preamble by using a RA resource associated with the SSB, per RA SSB information PerRASSBInfo-r16 corresponding to the SSB is recorded. It can be seen from the above that per RA attempt related information list perRAAttemptInfoList-r16 field in PerRASSBInfo-r16 must be carried. The perRAAttemptInfoList-r16 field contains the following contents:

| PerRAAttemptInfoList-r16 ::= | SEQUENCE (SIZE (1..200)) OF PerRAAttemptInfo-r16 | |
|---|---|---|
| PerRAAttemptInfo-r16 ::= | SEQUENCE { | |
| contentionDetected-r16 | BOOLEAN | OPTIONAL, |
| dlRSRPAboveThreshold-r16 | BOOLEAN | OPTIONAL, |

```
  ...,
  [[
```

| | | |
|---|---|---|
| fallbackToFourStepRA-r17 | ENUMERATED {true} | OPTIONAL |

]]
}

In the related art, for New Radio Unlicense (NR-U), whether the terminal device can send a preamble depends on whether the terminal device can successfully perform listen-before-talk (LBT). If LBT corresponding to preamble sending of the terminal device fails, the terminal device cannot send the preamble. Whether the per RA attempt related information list perRAAttemptInfoList-r16 contains random access attempt (RA attempt) related information that sending a preamble is unsuccessful due to the LBT failure is ambiguous.

Similarly, after radio link failure (RLF) occurs on the terminal device, the terminal device may also record an RLF report, which is reported in a manner similar to the connection establishment failure report. If the RLF is caused by a handover failure, the RLF report of the terminal device may include RA common information ra-InformationCommon, in which perRAInfoList-r16 must also be carried. In addition, a random access report (RA report) and a handover success report may also carry the ra-InformationCommon. Secondary cell group (SCG) failure information may carry perRAInfoList-r16. Therefore, the same problem mentioned above may also be encountered.

In view of this, the embodiments of the present disclosure provide information reporting methods, where a terminal device, when sending a RA preamble by using a RA resource associated with a reference signal, reports, to a network-side device, RA attempt related information on the reference signal. In this way, the terminal device, when sending the RA preamble by using the RA resource associated with the reference signal, can support reporting, to the network-side device, the RA attempt related information on the reference signal.

The information reporting methods and apparatuses provided in the present disclosure will be described in detail below with reference to the accompanying drawings.

Referring to FIG. 2, FIG. 2 is a flowchart of an information reporting method according to an embodiment of the present disclosure. As shown in FIG. 2, the method may include, but is not limited to, the following step S21.

At step S21, the terminal device reports, in response to sending a RA preamble by using a RA resource associated with a reference signal, RA attempt related information on the reference signal to the network-side device, where the reference signal includes an SSB or a CSI-RS.

In the embodiments of the present disclosure, the terminal device reports the RA attempt related information on the reference signal to the network-side device, when sending the RA preamble by using the RA resource associated with the reference signal.

Cases in which the terminal device sends the RA preamble by using the RA resource associated with the reference signal may include case I, case II, case III, and the like. In the case I, the terminal device sends the RA preamble by using the RA resource associated with the reference signal and does not perform LBT. In the case II, the terminal device sends the RA preamble by using the RA resource associated with the reference signal, and performs LBT successfully, and thus successfully sends the RA preamble. In the case III, the terminal device unsuccessfully sends the RA preamble by using the RA resource associated with the reference signal due to a LBT failure.

In some possible implementations, the case in which the terminal device sends the RA preamble by using the RA resource associated with the reference signal includes the case I, in which the terminal device sends the RA preamble by using the RA resource associated with the reference signal and does not perform LBT. In this case, the RA attempt related information on the reference signal reported by the terminal device to the network-side device can include information related to the terminal device sending the RA preamble by using the RA resource associated with the reference signal.

In some possible implementations, the case in which the terminal device sends the RA preamble by using the RA resource associated with the reference signal includes the case II, in which the terminal device sends the RA preamble by using the RA resource associated with the reference signal, and performs LBT successfully, and thus successfully sends the RA preamble. In this case, the RA attempt related information on the reference signal reported by the terminal device to the network-side device can include information related to the terminal device successfully sending the RA preamble by using the RA resource associated with the reference signal.

In some possible implementations, the case in which the terminal device sends the RA preamble by using the RA resource associated with the reference signal includes the case III, in which the terminal device unsuccessfully sends the RA preamble by using the RA resource associated with the reference signal due to a LBT failure. In this case, the RA attempt related information on the reference signal reported by the terminal device to the network-side device can include information related to the terminal device sending the RA preamble by using the RA resource associated with the reference signal, with the LBT failure.

The terminal device sends the RA preamble by using the RA resource associated with the reference signal, where the reference signal may include an SSB or a CSI-RS.

In the embodiments of the present disclosure, the terminal device reports RA attempt related information on an SSB to the network-side device, when the terminal device sends a RA preamble by using a RA resource associated with the SSB.

For example, in the case that the reference signal is an SSB, the terminal device reports RA attempt related information on an SSB #1 to the network-side device, when the terminal device sends a RA preamble by using a RA resource associated with the SSB #1.

In the embodiments of the present disclosure, the terminal device reports RA attempt related information on a CSI-RS to the network-side device, when the terminal device sends a RA preamble by using a RA resource associated with the CSI-RS.

For example, in the case that the reference signal is a CSI-RS, the terminal device reports RA attempt related information on a CSI-RS #1 to the network-side device, when the terminal device sends a RA preamble by using a RA resource associated with the CSI-RS #1.

In the embodiments of the present disclosure, when the terminal device sends the RA preamble by using the RA resource associated with the reference signal, the terminal device may pre-store the RA attempt related information on the reference signal, and report the RA attempt related information on the reference signal to the network-side device when the network-side device requests.

In the embodiments of the present disclosure, when the terminal device sends the RA preamble by using the RA resource associated with the reference signal, the terminal device reports the RA attempt related information on the reference signal to the network-side device, so that the network-side device may receive the RA attempt related information on the reference signal reported by the terminal device. The RA attempt related information on the reference signal is reported by the terminal device when the terminal device sends the RA preamble by using the RA resource associated with the reference signal, where the reference signal includes an SSB or a CSI-RS.

In some embodiments, the terminal device reporting the RA attempt related information on the reference signal to the network-side device, in response to sending the RA preamble by using the RA resource associated with the reference signal, includes:
in response to successfully sending the RA preamble by using the RA resource associated with the reference signal, reporting the RA attempt related information on the reference signal to the network-side device;
in response to that sending the RA preamble by using the RA resource associated with the reference signal is unsuccessful due to a LBT failure, reporting the RA attempt related information on the reference signal to the network-side device; or
in response to that sending the RA preamble by using a RA resource associated with any one of a plurality of reference signals is unsuccessful, selecting one or more reference signals from the plurality of reference signals, and reporting the RA attempt related information on the selected one or more reference signals to the network-side device.

In the embodiments of the present disclosure, the terminal device reporting the RA attempt related information on the reference signal to the network-side device, when sending the RA preamble by using the RA resource associated with the reference signal, includes: reporting the RA attempt related information on the reference signal to the network-side device, when successfully sending the RA preamble by using the RA resource associated with the reference signal.

In the embodiments of the present disclosure, the terminal device reporting the RA attempt related information on the reference signal to the network-side device, when sending the RA preamble by using the RA resource associated with the reference signal, includes: reporting the RA attempt related information on the reference signal to the network-side device, when sending the RA preamble by using the RA resource associated with the reference signal is unsuccessful due to a LBT failure.

In the embodiments of the present disclosure, the terminal device reporting the RA attempt related information on the reference signal to the network-side device, when sending the RA preamble by using the RA resource associated with the reference signal, includes: selecting one or more reference signals from a plurality of reference signals and reporting the RA attempt related information on the selected one or more reference signals to the network-side device, when sending the RA preamble by using the RA resource associated with any one of the plurality of reference signals is unsuccessful.

It should be noted that the foregoing embodiments are not exhaustive, and are merely examples of some embodiments. The foregoing embodiments may be implemented individually, or may be implemented in combination. The foregoing embodiments are merely illustrative and are not intended to constitute a specific limitation on the scope of protection of the disclosed embodiments.

In some embodiments, each attempt of sending the RA preamble by using the RA resource associated with the reference signal is counted as one RA attempt on the reference signal, whether the LBT succeeds or not. The RA attempt related information on the reference signal includes information related to each RA attempt on the reference signal.

In the embodiments of the present disclosure, the RA attempt related information on the reference signal reported by the terminal device to the network-side device includes information related to each RA attempt on the reference signal.

Each attempt of sending the RA preamble by using the RA resource associated with the reference signal is counted as one RA attempt on the reference signal, whether the LBT succeeds or not.

In the embodiments of the present disclosure, each attempt of sending the RA preamble by using the RA resource associated with the reference signal is counted as one RA attempt on the reference signal, whether the LBT succeeds or not. When the RA attempt related information on the reference signal includes information related to each RA attempt on the reference signal, the terminal device may report the RA attempt related information on the reference signal to the network-side device without being configured with lbt-FailureRecoveryConfig.

In some embodiments, when unsuccessfully sending the RA preamble by using the RA resource associated with the reference signal due to the LBT failure is counted as one RA attempt on the reference signal, the RA attempt related information on the reference signal includes: information related to that sending the RA preamble by using the RA resource associated with the reference signal is unsuccessful due to the LBT failure.

In some embodiments, the RA attempt related information on the reference signal includes at least one of:
a downlink reference signal received power being greater than a threshold, dlRSRPAboveThreshold; or
sending the RA preamble being failed due to the LBT failure.

In the embodiments of the present disclosure, for one RA attempt, if sending the RA preamble is unsuccessful due to the LBT failure, the terminal device reports, to the network-side device, the RA attempt related information on the reference signal, which includes the dlRSRPAboveThreshold. For example, the terminal device reports, to the network-side device, the RA attempt related information on the reference signal, which includes dlRSRPAboveThreshold-r16.

In the embodiments of the present disclosure, for one RA attempt, if sending the RA preamble is unsuccessful due to the LBT failure, the RA attempt related information on the reference signal reported by the terminal device to the network-side device includes sending the RA preamble being failed due to the LBT failure.

It should be noted that the foregoing embodiments are not exhaustive, and are merely examples of some embodiments. The foregoing embodiments may be implemented individually, or may be implemented in combination. The foregoing embodiments are merely illustrative and are not intended to constitute a specific limitation on the scope of protection of the disclosed embodiments.

In some embodiments, the RA attempt related information on the reference signal does not include at least one of:

contention detected, contentionDetected; or
fallback to four step RA, fallbackToFourStepRA.

In the embodiments of the present disclosure, for one RA attempt, if sending the RA preamble is unsuccessful due to the LBT failure, the terminal device reports the RA attempt related information on the reference signal to the network-side device, where the RA attempt related information does not include the contentionDetected. For example, the terminal device reports the RA attempt related information on the reference signal to the network-side device, where the RA attempt related information does not include contentionDetected-r16.

In the embodiments of the present disclosure, for one RA attempt, if sending the RA preamble is unsuccessful due to the LBT failure, the terminal device reports the RA attempt related information on the reference signal to the network-side device, where the RA attempt related information does not include the fallbackToFourStepRA. For example, the terminal device reports the RA attempt related information on the reference signal to the network-side device, where the RA attempt related information does not include fallbackToFourStepRA-r17.

It should be noted that the foregoing embodiments are not exhaustive, and are merely examples of some embodiments. The foregoing embodiments may be implemented individually, or may be implemented in combination. The foregoing embodiments are merely illustrative and are not intended to constitute a specific limitation on the scope of protection of the disclosed embodiments.

In some embodiments, each attempt of sending the RA preamble by using the RA resource associated with the reference signal is counted as one RA attempt on the reference signal, only when the RA preamble is successfully sent. The RA attempt related information on the reference signal includes information related to each RA attempt on the reference signal.

In the embodiments of the present disclosure, each attempt of sending the RA preamble by using the RA resource associated with the reference signal is counted as one RA attempt on the reference signal only when the RA preamble is successfully sent. In this case, the RA attempt related information on the reference signal reported by the terminal device to the network-side device includes information related to each RA attempt on the reference signal, for example, includes information related to successfully sending the RA preamble by using the RA resource associated with the reference signal.

In the embodiments of the present disclosure, each attempt of sending the RA preamble by using the RA resource associated with the reference signal is counted as one RA attempt on the reference signal only when the RA preamble is successfully sent. The RA attempt related information on the reference signal includes information related to each RA attempt on the reference signal. In this case, the terminal device reports the RA attempt related information on the reference signal to the network-side device only when the terminal device is configured with lbt-FailureRecoveryConfig.

In the embodiments of the present disclosure, each attempt of sending the RA preamble by using the RA resource associated with the reference signal is counted as one RA attempt on the reference signal only when the RA preamble is successfully sent. The RA attempt related information on the reference signal recorded by the terminal device further includes: a number of continuous failures of sending the RA preamble by using the RA resource associated with the reference signal due to LBT failure, before successfully sending the RA preamble by using the RA resource associated with the reference signal.

In some embodiments, the terminal device reporting the RA attempt related information on the reference signal to the network-side device, includes: reporting a RA information list to the network-side device, where the RA information list includes the RA attempt related information on the reference signal.

In the embodiments of the present disclosure, when the terminal device reports the RA attempt related information on the reference signal to the network-side device, the terminal device may report, to the network-side device, a newly defined RA information list (PerRAInfoList), for example, PerRAInfoList-r18, which includes fields for indicating the information related to each of the RA attempts.

In some possible implementations, if PerRAInfoList-r16 is a mandatory field in an information element (IE) of an existing report, the IE of the report may be redefined. For example, the report may include a connection establishment failure report or a RA report. The redefined report includes the newly defined PerRAInfoList.

In some possible implementations, if PerRAInfoList-r16 is an optional field in an existing report, a newly defined PerRAInfoList-r18 version may be used instead of the PerRAInfoList-r16 version. For example, the report may include an RLF report caused by a handover failure or a RA problem, a handover success report triggered by a timer T304, and SCG (Secondary Cell Group) failure information report triggered by a RA failure or addition/change of SCG.

In some possible implementations, the terminal device may use the newly defined PerRAInfoList only when the number of times a preamble is sent on one SSB or CSI-RS is 0. Alternatively, the terminal device may use the newly defined PerRAInfoList in all cases. When the number of times a preamble is sent is 0, fields in the PerRAInfoList for indicating the RA attempt related information are not reported.

In some embodiments, the terminal device reporting the RA attempt related information on the reference signal to the network-side device, includes at least one of:
reporting a connection establishment failure report to the network-side device, where the connection establishment failure report includes the RA attempt related information on the reference signal;
reporting a RA report to the network-side device, where the RA report includes the RA attempt related information on the reference signal;
reporting a radio link failure (RLF) report to the network-side device, where the RLF report includes the RA attempt related information on the reference signal;
reporting secondary cell group (SCG) failure information to the network-side device, where the SCG failure information includes the RA attempt related information on the reference signal;
reporting a handover success report to the network-side device, where the handover success report includes the RA attempt related information on the reference signal;
reporting a primary secondary cell (PScell) addition success report to the network-side device, where the PScell addition success report includes the RA attempt related information on the reference signal; or
reporting a PScell change success report to the network-side device, where the PScell change success report includes the RA attempt related information on the reference signal.

In the embodiments of the present disclosure, the terminal device reporting the RA attempt related information on the reference signal to the network-side device, when sending the RA preamble by using the RA resource associated with the reference signal, includes reporting the connection establishment failure report to the network-side device, where the connection establishment failure report includes the RA attempt related information on the reference signal.

In the embodiments of the present disclosure, the terminal device reporting the RA attempt related information on the reference signal to the network-side device, when sending the RA preamble by using the RA resource associated with the reference signal, includes reporting the RA report to the network-side device, where the RA report includes the RA attempt related information on the reference signal.

In the embodiments of the present disclosure, the terminal device reporting the RA attempt related information on the reference signal to the network-side device, when sending the RA preamble by using the RA resource associated with the reference signal, includes reporting the radio link failure RLF report to the network-side device, where the RLF report includes the RA attempt related information on the reference signal.

In the embodiments of the present disclosure, the terminal device reporting the RA attempt related information on the reference signal to the network-side device, when sending the RA preamble by using the RA resource associated with the reference signal, includes reporting the secondary cell group SCG failure information to the network-side device, where the SCG failure information includes the RA attempt related information on the reference signal.

In the embodiments of the present disclosure, the terminal device reporting the RA attempt related information on the reference signal to the network-side device, when sending the RA preamble by using the RA resource associated with the reference signal, includes reporting the handover success report to the network-side device, where the handover success report includes the RA attempt related information on the reference signal.

In the embodiments of the present disclosure, the terminal device reporting the RA attempt related information on the reference signal to the network-side device, when sending the RA preamble by using the RA resource associated with the reference signal, includes reporting the primary secondary cell (PScell) addition success report to the network-side device, where the PScell addition success report includes the RA attempt related information on the reference signal.

In the embodiments of the present disclosure, the terminal device reporting the RA attempt related information on the reference signal to the network-side device, when sending the RA preamble by using the RA resource associated with the reference signal, includes reporting the PScell change success report to the network-side device, where the PScell change success report includes the RA attempt related information on the reference signal.

It should be noted that the foregoing embodiments are not exhaustive, and are merely examples of some embodiments. The foregoing embodiments may be implemented individually, or may be implemented in combination. The foregoing embodiments are merely illustrative and are not intended to constitute a specific limitation on the scope of protection of the disclosed embodiments.

In the embodiments of the present disclosure, before reporting, to the network-side device, any one of the connection establishment failure report, the RA report, the RLF report, the SCG failure information, the handover success report, the PScell addition success report, and the PScell change success report, the terminal device may record the RA attempt related information on the reference signal in a corresponding variable of the report, and then report the report to the network-side device when the network-side device requests, so as to report the RA attempt related information on the reference signal to the network-side device.

With implementation of the embodiments of the present disclosure, the terminal device reports the RA attempt related information on the reference signal to the network-side device, when sending the RA preamble by using the RA resource associated with the reference signal, where the reference signal includes an SSB or a CSI-RS. Therefore, the terminal device supports reporting of the RA attempt related information on the reference signal to the network-side device, when sending the RA preamble by using the RA resource associated with the reference signal.

Referring to FIG. 3, FIG. 3 is a flowchart of an information reporting method according to another embodiment of the present disclosure. As shown in FIG. 3, the method may include, but is not limited to, the following step S31.

At step S31, in response to successfully sending the RA preamble by using the RA resource associated with the reference signal, the terminal device reports the RA attempt related information on the reference signal to the network-side device, where the reference signal includes an SSB or a CSI-RS.

In the embodiments of the present disclosure, the terminal device reports the RA attempt related information on the reference signal to the network-side device, when successfully sending the RA preamble by using the RA resource associated with the reference signal.

A case in which the terminal device successfully sends the RA preamble by using the RA resource associated with the reference signal may include a case in which the terminal device sends the RA preamble by using the RA resource associated with the reference signal, and performs LBT successfully and thus successfully sends the RA preamble.

In the embodiments of the present disclosure, the terminal device reports RA attempt related information on one of reference signals to the network-side device, only when successfully sending a RA preamble by using a RA resource associated with the one reference signal.

For example, in the case that the reference signal is an SSB, the terminal device reports RA attempt related information on an SSB #1 to the network-side device, only when the terminal device successfully sends a RA preamble by using a RA resource associated with the SSB #1.

For example, in the case that the reference signal is a CSI-RS, the terminal device reports RA attempt related information on a CSI-RS #1 to the network-side device, only when the terminal device successfully sends a RA preamble by using a RA resource associated with the CSI-RS #1.

In some embodiments, the terminal device reports information related to one or more RA attempts on a reference signal to the network-side device, when the terminal device successfully send a RA preamble by using a RA resource associated with the reference signal and is not configured with lbt-FailureRecoveryConfig, where the reference signal includes an SSB or a CSI-RS.

Contents included in the RA attempt related information on the reference signal reported by the terminal device to the network-side device and methods in which the terminal device reports the RA attempt related information on the reference signal to the network-side device, can be found in relevant descriptions in the foregoing embodiments, and will not be repeated herein.

It should be noted that, in the embodiments of the present disclosure, step S31 may be implemented individually, or may be implemented in combination with any other step in the embodiments of the present disclosure. For example, step S31 may be implemented in combination with step S21 in the embodiments of the present disclosure, which is not limited in the embodiments of the present disclosure.

With implementation of the embodiments of the present disclosure, the terminal device reports the RA attempt related information on the reference signal to the network-side device, when successfully sending the RA preamble by using the RA resource associated with the reference signal, where the reference signal includes an SSB or a CSI-RS. Therefore, the terminal device supports reporting of the RA attempt related information on the reference signal to the network-side device, when successfully sending the RA preamble by using the RA resource associated with the reference signal.

Referring to FIG. 4, FIG. 4 is a flowchart of an information reporting method according to yet another embodiment of the present disclosure. As shown in FIG. 4, the method may include, but is not limited to, the following step S41.

At step S41, in response to that sending a RA preamble by using a RA resource associated with the reference signal is unsuccessful due to the LBT failure, the terminal device reports RA attempt related information on a reference signal to the network-side device, where the reference signal includes an SSB or a CSI-RS.

In the embodiments of the present disclosure, the terminal device reports the RA attempt related information on the reference signal to the network-side device, when sending the RA preamble by using the RA resource associated with the reference signal is unsuccessful due to the LBT failure.

For example, in the case that the reference signal is an SSB, the terminal device reports RA attempt related information on an SSB #1 to the network-side device, when sending a RA preamble by using a RA resource associated with the SSB #1 is unsuccessful due to the LBT failure.

For example, in the case that the reference signal is a CSI-RS, the terminal device reports RA attempt related information on a CSI-RS #1 to the network-side device, when sending a RA preamble by using a RA resource associated with the CSI-RS #1 is unsuccessful due to the LBT failure.

Contents included in the RA attempt related information on the reference signal reported by the terminal device to the network-side device and methods in which the terminal device reports the RA attempt related information on the reference signal to the network-side device, can be found in relevant descriptions in the foregoing embodiments, and will not be repeated herein.

It should be noted that, in the embodiments of the present disclosure, step S41 may be implemented individually, or may be implemented in combination with any other step in the embodiments of the present disclosure. For example, step S41 may be implemented in combination with step S21 in the embodiments of the present disclosure, which is not limited in the embodiments of the present disclosure.

With implementation of the embodiments of the present disclosure, the terminal device reports the RA attempt related information on the reference signal to the network-side device, when sending the RA preamble by using the RA resource associated with the reference signal is unsuccessful due to the LBT failure, where the reference signal includes an SSB or a CSI-RS. Therefore, the terminal device supports reporting of the RA attempt related information on the reference signal to the network-side device, when the terminal device unsuccessfully sends the RA preamble by using the RA resource associated with the reference signal due to the LBT failure.

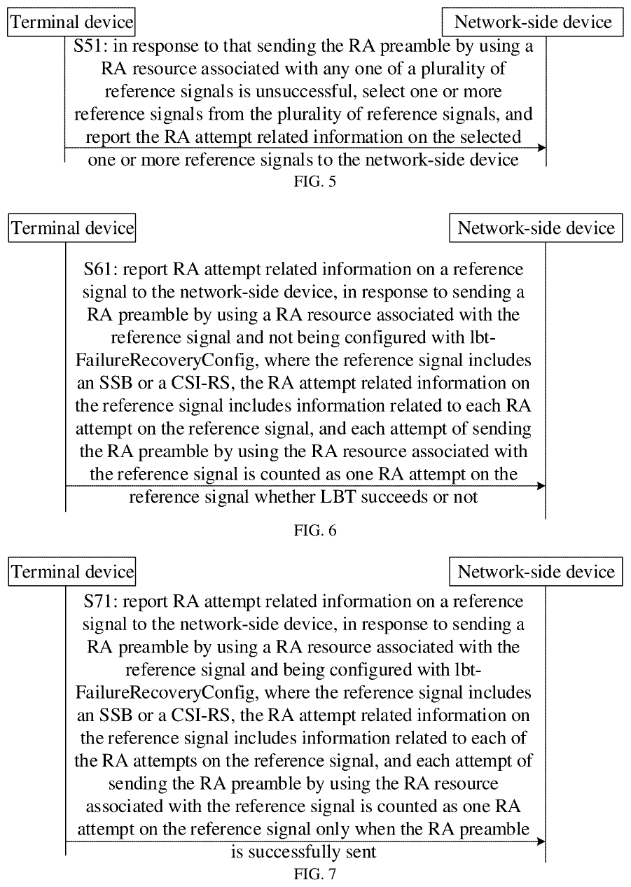

Referring to FIG. 5, FIG. 5 is a flowchart of an information reporting method according to yet another embodiment of the present disclosure. As shown in FIG. 5, the method may include, but is not limited to, the following step S51.

At step S51, in response to that sending the RA preamble by using a RA resource associated with any one of a plurality of reference signals is unsuccessful, the terminal device selects one or more reference signals from the plurality of reference signals, and reports the RA attempt related information on the selected one or more reference signals to the network-side device, where the reference signals include SSBs or CSI-RSs.

In the embodiments of the present disclosure, when the terminal device unsuccessfully send the RA preamble by using the RA resource associated with any one of the reference signals, the terminal device may select one or more reference signals from the plurality of reference signals, and report the RA attempt related information on the selected one or more reference signals to the network-side device.

When the terminal device selects one or more reference signals from the plurality of reference signals, the terminal device may select a reference signal that is first used in sending a RA preamble by using RA resources associated with the reference signals. In an example, the terminal device may select a reference signal that is last used in sending the RA preamble by using the RA resources associated with the reference signals. In an example, the terminal device may select a reference signal that is most frequently used in sending the RA preamble by using the RA resources associated with the reference signals. In an example, the terminal device may select a reference signal with the worst downlink Reference Signal Received Power (RSRP) used in sending the RA preamble by using the RA resources associated with the reference signals. This is not specifically limited in the embodiments of the present disclosure.

When the terminal device selects one or more reference signals from the reference signals, the terminal device may select a reference signal for the first attempt, a reference signal for the last attempt, a reference signal for most frequent attempts, a reference signal with the worst downlink Reference Signal Received Power (RSRP), or the like, which is not specifically limited in the embodiments of the present disclosure.

For example, in the case that the reference signals are SSBs, when the terminal device sends a RA preamble by using RA resources associated with SSB #1, SSB #2, and SSB #3, and unsuccessfully send the RA preamble by using a RA resource associated with any one of the SSB #1, the SSB #2, and the SSB #3, the terminal device may select one or more from the SSB #1, the SSB #2, and the SSB #3 as target reference signals. If the terminal device selects the SSB #3 as the target reference signal, the terminal device may report RA attempt related information on the SSB #3 to the network-side device.

For example, in the case that the reference signals are CSI-RSs, when the terminal device sends a RA preamble by using RA resources associated with CSI-RS #1, CSI-RS #2, and CSI-RS #3, and unsuccessfully send the RA preamble by using a RA resource associated with any one of the CSI-RS #1, the CSI-RS #2, and the CSI-RS #3, the terminal device may select one or more from the CSI-RS #1, the CSI-RS #2, and the CSI-RS #3 as target reference signals. If the terminal device selects the CSI-RS #2 as the target reference signal, the terminal device may report RA attempt related information on the CSI-RS #2 to the network-side device.

In the embodiments of the present disclosure, when the terminal device unsuccessfully sends the RA preamble by using the RA resource associated with any one of the reference signals, the terminal device may select one or more reference signals from the reference signals, and report the RA attempt related information on the selected one or more reference signals to the network-side device, which is only applicable to a connection establishment failure report, an RLF report caused by a handover failure or a RA problem, a RA report caused by a RA failure, a handover success report triggered by T304, and SCG failure information report triggered by a RA failure or addition/change of SCG.

Contents included in the RA attempt related information on the reference signal reported by the terminal device to the network-side device and methods in which the terminal device reports the RA attempt related information on the reference signal to the network-side device, can be found in relevant descriptions in the foregoing embodiments, and will not be repeated herein.

It should be noted that, in the embodiments of the present disclosure, step S51 may be implemented individually, or may be implemented in combination with any other step in the embodiments of the present disclosure. For example, step S51 may be implemented in combination with step S21 in the embodiments of the present disclosure, which is not limited in the embodiments of the present disclosure.

With implementation of the embodiments of the present disclosure, when the terminal device unsuccessfully sends the RA preamble by using the RA resource associated with any one of the plurality of reference signals, the terminal device selects one or more reference signals from the plurality of reference signals, and reports the RA attempt related information on the selected one or more reference signals to the network-side device, where the reference signals include SSBs or CSI-RSs. Therefore, the terminal device supports selecting of one or more reference signals from a plurality of reference signals, and reporting RA attempt related information on the selected one or more reference signals to the network-side device, when unsuccessfully send a RA preamble by using a RA resource associated with any one of the plurality of reference signals.

Referring to FIG. 6, FIG. 6 is a flowchart of an information reporting method according to yet another embodiment of the present disclosure. As shown in FIG. 6, the method may include, but is not limited to, the following step S61.

At step S61, the terminal device reports RA attempt related information on a reference signal to the network-side device, in response to sending a RA preamble by using a RA resource associated with the reference signal and not being configured with lbt-FailureRecoveryConfig, where the reference signal includes an SSB or a CSI-RS, the RA attempt related information on the reference signal includes information related to each RA attempt on the reference signal, and each attempt of sending the RA preamble by using the RA resource associated with the reference signal is counted as one RA attempt on the reference signal whether LBT succeeds or not.

In the embodiments of the present disclosure, the RA attempt related information on the reference signal reported by the terminal device to the network-side device includes information related to each RA attempt on the reference signal.

Each attempt of sending the RA preamble by using the RA resource associated with the reference signal is counted as one RA attempt on the reference signal whether LBT succeeds or not.

In the embodiments of the present disclosure, each attempt of sending the RA preamble is counted as one RA attempt whether LBT succeeds or not. When the RA attempt related information on the reference signal includes information related to each RA attempt on the reference signal, the terminal device may report the RA attempt related information on the reference signal to the network-side device without being configured with lbt-FailureRecoveryConfig.

In some embodiments, when sending the RA preamble by using the RA resource associated with the reference signal is unsuccessful due to the LBT failure, the RA attempt related information on the reference signal includes: information related to that sending the RA preamble by using the RA resource associated with the reference signal is unsuccessful due to the LBT failure.

In the embodiments of the present disclosure, when unsuccessfully sending the RA preamble by using the RA resource associated with the reference signal due to the LBT failure is counted as one RA attempt on the reference signal, the RA attempt related information on the reference signal reported by the terminal device to the network-side device includes: information related to that sending the RA preamble by using the RA resource associated with the reference signal is unsuccessful due to the LBT.

In some embodiments, the RA attempt related information on the reference signal includes at least one of:
a downlink reference signal received power being greater than a threshold, dlRSRPAboveThreshold; or
sending the RA preamble being failed due to the LBT failure.

In the embodiments of the present disclosure, for one RA attempt, if the terminal device unsuccessfully send the RA preamble due to the LBT failure, the terminal device reports, to the network-side device, the RA attempt related information on the reference signal, which includes the dlRSRPAboveThreshold. For example, the terminal device reports, to the network-side device, the RA attempt related information on the reference signal, which includes dlRSRPAboveThreshold-r16.

In the embodiments of the present disclosure, for one RA attempt, if the terminal device unsuccessfully send the RA preamble due to the LBT failure of, the terminal device reports, to the network-side device, the RA attempt related information on the reference signal, which includes unsuccessfully send the RA preamble due to the LBT failure.

It should be noted that the foregoing embodiments are not exhaustive, and are merely examples of some embodiments. The foregoing embodiments may be implemented individually, or may be implemented in combination. The foregoing embodiments are merely illustrative and are not intended to constitute a specific limitation on the scope of protection of the disclosed embodiments.

In some embodiments, the RA attempt related information on the reference signal does not include at least one of:

contention detected, contentionDetected; or
fallback to four step RA, fallbackToFourStepRA.

In the embodiments of the present disclosure, for one RA attempt, if the terminal device unsuccessfully send the RA preamble due to the LBT failure, the terminal device reports the RA attempt related information on the reference signal to the network-side device, where the RA attempt related information does not include the contentionDetected. For example, the terminal device reports the RA attempt related information on the reference signal to the network-side device, where the RA attempt related information does not include contentionDetected-r16.

In the embodiments of the present disclosure, for one RA attempt, if the terminal device unsuccessfully send the RA preamble due to the LBT failure, the terminal device reports the RA attempt related information on the reference signal to the network-side device, where the RA attempt related information does not include the fallbackToFourStepRA. For example, the terminal device reports the RA attempt related information on the reference signal to the network-side device, where the RA attempt related information does not include fallbackToFourStepRA-r17.

It should be noted that the foregoing embodiments are not exhaustive, and are merely examples of some embodiments. The foregoing embodiments may be implemented individually, or may be implemented in combination. The foregoing embodiments are merely illustrative and are not intended to constitute a specific limitation on the scope of protection of the disclosed embodiments.

Methods in which the terminal device reports the RA attempt related information on the reference signal to the network-side device, can be found in relevant descriptions in the foregoing embodiments, and will not be repeated herein.

It should be noted that, in the embodiments of the present disclosure, step S61 may be implemented individually, or may be implemented in combination with any other step in the embodiments of the present disclosure. For example, step S61 may be implemented in combination with step S21 and/or step S31 and/or step S41 and/or step S51 in the embodiments of the present disclosure, which is not limited in the embodiments of the present disclosure.

With implementation of the embodiments of the present disclosure, the terminal device reports the RA attempt related information on the reference signal to the network-side device, when the terminal device is not configured with LBT failure recovery configuration lbt-FailureRecoveryConfig, where the reference signal includes an SSB or a CSI-RS. Each attempt of sending the RA preamble by using the RA resource associated with the reference signal is counted as one RA attempt on the reference signal, whether LBT succeeds or not, where the RA attempt related information on the reference signal includes information related to each of the RA attempts on the reference signal. In this way, the terminal device supports reporting of the RA attempt related information on the reference signal to the network-side device, when the terminal device sends the RA preamble by using the RA resource associated with the reference signal and is not configured with lbt-FailureRecoveryConfig. The RA attempt related information on the reference signal includes information related to each of the RA attempts on the reference signal. Each attempt of sending the RA preamble by using the RA resource associated with the reference signal is counted as one RA attempt on the reference signal, whether LBT succeeds or not.

Referring to FIG. 7, FIG. 7 is a flowchart of an information reporting method according to yet another embodiment of the present disclosure. As shown in FIG. 7, the method may include, but is not limited to, the following step S71.

At step S71, the terminal device reports RA attempt related information on a reference signal to the network-side device, in response to sending a RA preamble by using a RA resource associated with the reference signal and being configured with lbt-FailureRecoveryConfig, where the reference signal includes an SSB or a CSI-RS, the RA attempt related information on the reference signal includes information related to each of the RA attempts on the reference signal, and each attempt of sending the RA preamble by using the RA resource associated with the reference signal is counted as one RA attempt on the reference signal only when the RA preamble is successfully sent.

In the embodiments of the present disclosure, each attempt of sending the RA preamble by using the RA resource associated with the reference signal is counted as one RA attempt on the reference signal, only when the RA preamble is successfully sent. In this case, the RA attempt related information on the reference signal reported by the terminal device to the network-side device includes information related to each RA attempt on the reference signal, for example, includes information related to successfully sending the RA preamble by using the RA resource associated with the reference signal.

In the embodiments of the present disclosure, each attempt of sending the RA preamble by using the RA resource associated with the reference signal is counted as one RA attempt on the reference signal, only when the RA preamble is successfully sent. The RA attempt related information on the reference signal includes information related to each of the RA attempt on the reference signal. In this case, the terminal device reports the RA attempt related information on the reference signal to the network-side device, only when the terminal device is configured with lbt-FailureRecoveryConfig.

In the embodiments of the present disclosure, each attempt of sending the RA preamble by using the RA resource associated with the reference signal is counted as one RA attempt on the reference signal, only when the RA preamble is successfully sent. The RA attempt related information on the reference signal recorded by the terminal device further includes: a number of continuous failures of sending the RA preamble by using the RA resource associated with the reference signal due to LBT failure, before successfully sending the RA preamble by using the RA resource associated with the reference signal.

Methods in which the terminal device reports the RA attempt related information on the reference signal to the network-side device, can be found in relevant descriptions in the foregoing embodiments, and will not be repeated herein.

It should be noted that, in the embodiments of the present disclosure, step S71 may be implemented individually, or may be implemented in combination with any other step in the embodiments of the present disclosure. For example, step S71 may be implemented in combination with step S21 and/or step S31 and/or step S41 and/or step S51 in the embodiments of the present disclosure, which is not limited in the embodiments of the present disclosure.

With implementation of the embodiments of the present disclosure, the terminal device reports the RA attempt related information on the reference signal to the network-side device, when sending the RA preamble by using the RA resource associated with the reference signal and being configured with lbt-FailureRecoveryConfig. The reference signal includes an SSB or a CSI-RS. The RA attempt related information on the reference signal includes information related to each RA attempt on the reference signal. Each attempt of sending the RA preamble by using the RA resource associated with the reference signal is counted as one RA attempt on the reference signal, only when the RA preamble is successfully sent. Therefore, the terminal device supports reporting of the RA attempt related information on the reference signal to the network-side device, when sending the RA preamble by using the RA resource associated with the reference signal and being configured with lbt-FailureRecoveryConfig. The RA attempt related information on the reference signal includes information related to each RA attempt on the reference signal. Each attempt of sending the RA preamble by using the RA resource associated with the reference signal is counted as one RA attempt on the reference signal, only when the RA preamble is successfully sent.

Referring to FIG. 8, FIG. 8 is a flowchart of an information reporting method according to yet another embodiment of the present disclosure. As shown in FIG. 8, the method may include, but is not limited to, the following step S81.

At step S81, the terminal device reports a RA information list to the network-side device, in response to sending a RA preamble by using a RA resource associated with a reference signal, where the RA information list includes RA attempt related information on the reference signal, and the reference signal includes an SSB or a CSI-RS.

In the embodiments of the present disclosure, when the terminal device reports the RA attempt related information on the reference signal to the network-side device, the terminal device may report, to the network-side device, a newly defined RA information list (PerRAInfoList), for example, PerRAInfoList-r18, which includes fields for indicating information related to each of the RA attempts.

In some possible implementations, if PerRAInfoList-r16 is a mandatory field in an information element (IE) of an existing report, the IE of the report may be redefined. For example, the report may include a connection establishment failure report or a RA report. The redefined report includes the newly defined PerRAInfoList.

In some possible implementations, if PerRAInfoList-r16 is an optional field in an existing report, a newly defined PerRAInfoList-r18 version may be used instead of the PerRAInfoList-r16 version. For example, the report may include an RLF report caused by a handover failure or a RA problem, a handover success report triggered by a timer T304, and SCG failure information report triggered by a RA failure or addition/change of SCG.

In some possible implementations, the terminal device may use the newly defined PerRAInfoList only when the number of times a RA preamble is sent on one SSB or CSI-RS is 0. Alternatively, the terminal device may use the newly defined PerRAInfoList in all cases. When the number of times a RA preamble is sent is 0, fields in the PerRAInfoList for indicating the RA attempt related information are not reported.

It should be noted that the RA information list includes the RA attempt related information on the reference signal, and contents included in the RA attempt related information on the reference signal may be found in relevant descriptions in the foregoing embodiments, and will not be repeated herein.

It should be noted that, in the embodiments of the present disclosure, step S81 may be implemented individually, or may be implemented in combination with any other step in the embodiments of the present disclosure. For example, step S81 may be implemented in combination with step S21 and/or step S31 and/or step S41 and/or step S51 and/or step S61 and/or step S71 in the embodiments of the present disclosure.

With implementation of the embodiments of the present disclosure, when the terminal device sends the RA preamble by using the RA resource associated with the reference signal, the terminal device reports the RA information list to the network-side device. The RA information list includes the RA attempt related information on the reference signal, and the reference signal includes an SSB or a CSI-RS. Therefore, the terminal device supports reporting of the RA attempt related information on the reference signal to the network-side device, when sending the RA preamble by using the RA resource associated with the reference signal.

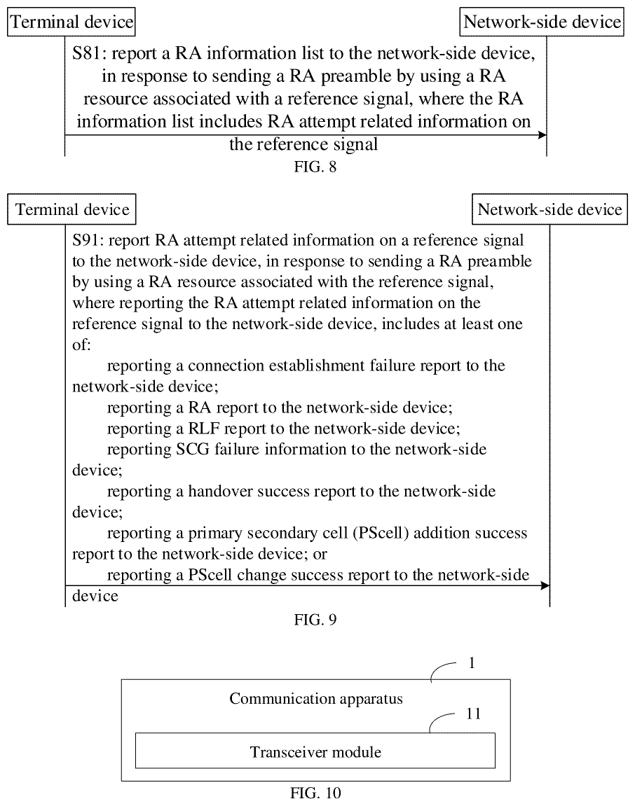

Referring to FIG. 9, FIG. 9 is a flowchart of an information reporting method according to yet another embodiment of the present disclosure. As shown in FIG. 9, the method may include, but is not limited to, the following step S91.

At step S91, the terminal device reports RA attempt related information on a reference signal to the network-side device, in response to sending a RA preamble by using a RA resource associated with the reference signal, where the reference signal includes an SSB or a CSI-RS, and reporting the RA attempt related information on the reference signal to the network-side device, includes at least one of:
reporting a connection establishment failure report to the network-side device, where the connection establishment failure report includes the RA attempt related information on the reference signal;
reporting a RA report to the network-side device, where the RA report includes the RA attempt related information on the reference signal;
reporting a radio link failure (RLF) report to the network-side device, where the RLF report includes the RA attempt related information on the reference signal;
reporting secondary cell group (SCG) failure information to the network-side device, where the SCG failure information includes the RA attempt related information on the reference signal;
reporting a handover success report to the network-side device, where the handover success report includes the RA attempt related information on the reference signal;
reporting a primary secondary cell (PScell) addition success report to the network-side device, where the PScell addition success report includes the RA attempt related information on the reference signal; or
reporting a PScell change success report to the network-side device, where the PScell change success report includes the RA attempt related information on the reference signal.

In the embodiments of the present disclosure, the terminal device reporting the RA attempt related information on the reference signal to the network-side device, when sending the RA preamble by using the RA resource associated with the reference signal, includes reporting the connection establishment failure report to the network-side device, where the connection establishment failure report includes the RA attempt related information on the reference signal.

In the embodiments of the present disclosure, the terminal device reporting the RA attempt related information on the reference signal to the network-side device, when sending the RA preamble by using the RA resource associated with the reference signal, includes reporting the RA report to the network-side device, where the RA report includes the RA attempt related information on the reference signal.

In the embodiments of the present disclosure, the terminal device reporting the RA attempt related information on the reference signal to the network-side device, when sending the RA preamble by using the RA resource associated with the reference signal, includes reporting the radio link failure RLF report to the network-side device, where the RLF report includes the RA attempt related information on the reference signal.

In the embodiments of the present disclosure, the terminal device reporting the RA attempt related information on the reference signal to the network-side device, when sending the RA preamble by using the RA resource associated with the reference signal, includes reporting the secondary cell group SCG failure information to the network-side device, where the SCG failure information includes the RA attempt related information on the reference signal.

In the embodiments of the present disclosure, the terminal device reporting the RA attempt related information on the reference signal to the network-side device, when sending the RA preamble by using the RA resource associated with the reference signal, includes reporting the handover success report to the network-side device, where the handover success report includes the RA attempt related information on the reference signal.

In the embodiments of the present disclosure, the terminal device reporting the RA attempt related information on the reference signal to the network-side device, when sending the RA preamble by using the RA resource associated with the reference signal, includes reporting the PScell addition success report to the network-side device, where the PScell addition success report includes the RA attempt related information on the reference signal.

In the embodiments of the present disclosure, the terminal device reporting the RA attempt related information on the reference signal to the network-side device, when sending the RA preamble by using the RA resource associated with the reference signal, includes reporting the PScell change success report to the network-side device, where the PScell change success report includes the RA attempt related information on the reference signal.

It should be noted that the foregoing embodiments are not exhaustive, and are merely examples of some embodiments. The foregoing embodiments may be implemented individually, or may be implemented in combination. The foregoing embodiments are merely illustrative and are not intended to constitute a specific limitation on the scope of protection of the disclosed embodiments.

In the embodiments of the present disclosure, before reporting, to the network-side device, any one of the connection establishment failure report, the RA report, the RLF report, the SCG failure information, the handover success report, the PScell addition success report, and the PScell change success report, the terminal device may record the RA attempt related information on the reference signal in a corresponding variable of the report, and then report the report to the network-side device when the network-side device requests, so as to report the RA attempt related information on the reference signal to the network-side device.

It should be noted that contents included in the RA attempt related information on the reference signal reported to the network-side device may be found in relevant descriptions in the foregoing embodiments, and will not be repeated herein.

With implementation of the embodiments of the present disclosure, the terminal device supports reporting of the RA attempt related information on the reference signal to the network-side device, when sending the RA preamble by using the RA resource associated with the reference signal.

With continued reference to FIG. 2, in the embodiments of the present disclosure, an information reporting method performed by a network-side device includes:

S21: the network-side device receiving RA attempt related information on a reference signal reported by a terminal device, where the RA attempt related information on the reference signal is reported by the terminal device when the terminal device sends a RA preamble by using a RA resource associated with the reference signal, and the reference signal includes an SSB or a CSI-RS.

As shown in FIG. 3 to FIG. 5, in some embodiments, the network-side device receiving the RA attempt related information on the reference signal reported by the terminal device, includes:

receiving the RA attempt related information on the reference signal reported by the terminal device, wherein the RA attempt related information on the reference signal is reported by the terminal device when successfully sending the preamble by using the RA resource associated with the reference signal;

receiving the RA attempt related information on the reference signal reported by the terminal device, wherein the RA attempt related information on the reference signal is reported by the terminal device when sending the preamble by using the RA resource associated with the reference signal is unsuccessful due to a listen-before-talk (LBT) failure; or
receiving RA attempt related information on one or more reference signals reported by the terminal device, wherein the information related to the RA attempts on the one or more reference signals is reported by the terminal device by selecting the one or more reference signals from a plurality of reference signals when sending the preamble by using a RA resource associated with any one of the plurality of reference signals is unsuccessful.

As shown in FIG. 6, in some embodiments, each attempt of sending a RA preamble by using a RA resource associated with a reference signal is counted as one RA attempt on the reference signal, whether LBT succeeds or not. The RA attempt related information on the reference signal includes information related to each RA attempt on the reference signal.

The network-side device receiving the RA attempt related information on the reference signal reported by the terminal device, includes: receiving the RA attempt related information on the reference signal reported by the terminal device, where the RA attempt related information on the reference signal is reported by the terminal device when the terminal device is not configured with lbt-FailureRecoveryConfig.

In some embodiments, when unsuccessfully sending the RA preamble by using the RA resource associated with the reference signal due to the LBT failure is counted as one RA attempt on the reference signal, the RA attempt related information on the reference signal includes: information related to that sending the RA preamble by using the RA resource associated with the reference signal is unsuccessful due to the LBT failure.

In some embodiments, the RA attempt related information on the reference signal includes at least one of:
a downlink reference signal received power being greater than a threshold, dlRSRPAboveThreshold; or
sending the RA preamble being failed due to the LBT failure.

In some embodiments, the RA attempt related information on the reference signal does not include at least one of:
contention detected, contentionDetected; or
fallback to four step RA, fallbackToFourStepRA.

As shown in FIG. 7, in some embodiments, each attempt of sending the RA preamble by using the RA resource associated with the reference signal is counted as one RA attempt on the reference signal, only when the RA preamble is successfully sent. The RA attempt related information on the reference signal includes information related to each of the RA attempts on the reference signal.

The network-side device receiving the RA attempt related information on the reference signal reported by the terminal device, includes: receiving the RA attempt related information on the reference signal reported by the terminal device, where the RA attempt related information on the reference signal is reported by the terminal device when the terminal device is configured with lbt-FailureRecoveryConfig.

In some embodiments, the RA attempt related information on the reference signal further includes: a number of continuous failures of sending the RA preamble by using the RA resource associated with the reference signal due to LBT failure, before successfully sending the RA preamble by using the RA resource associated with the reference signal.

As shown in FIG. 8, the network-side device receiving the RA attempt related information on the reference signal reported by the terminal device, includes: receiving a RA information list reported by the terminal device, where the RA information list includes the RA attempt related information on the reference signal.

As shown in FIG. 9, in some embodiments, the network-side device receiving the RA attempt related information on the reference signal reported by the terminal device, includes at least one of:
receiving a connection establishment failure report reported by the terminal device, where the connection establishment failure report includes the RA attempt related information on the reference signal;
receiving a RA report reported by the terminal device, where the RA report includes the RA attempt related information on the reference signal;
receiving a radio link failure (RLF) report reported by the terminal device, where the RLF report includes the RA attempt related information on the reference signal;
receiving secondary cell group (SCG) failure information reported by the terminal device, where the SCG failure information includes the RA attempt related information on the reference signal;
receiving a handover success report reported by the terminal device, where the handover success report includes the RA attempt related information on the reference signal;
receiving a primary secondary cell (PScell) addition success report reported by the terminal device, where the PScell addition success report includes the RA attempt related information on the reference signal; or
receiving a PScell change success report reported by the terminal device, where the PScell change success report includes the RA attempt related information on the reference signal.

It should be noted that the information reporting method performed by the network-side device in the embodiments of the present disclosure has been described in detail in the information reporting method performed by the terminal device. For details, reference can be made to the relevant descriptions of the information reporting method performed by the terminal device, which will not be repeated herein.

In the foregoing embodiments of the present disclosure, the information reporting method performed by the network-side device and the information reporting method performed by the terminal device have the same or similar beneficial effects, which will not be repeated herein.

In the foregoing embodiments of the present disclosure, the methods provided in the embodiments of the present disclosure are described from the perspective of interaction between a terminal device and a network-side device. To implement functions in the methods provided in the foregoing embodiments of the present disclosure, the terminal device and the network-side device may include a hardware structure and a software module, and implement the foregoing functions in a form of the hardware structure, the software module, or a combination of the hardware structure and the software module. A function in the foregoing functions may be performed by using a hardware structure, a software module, or a hardware structure plus a software module.

Referring to FIG. 10, FIG. 10 is a schematic structural diagram of a communication apparatus 1 according to an embodiment of the present disclosure. The communication apparatus 1 shown in FIG. 10 may include a transceiver module 11 and a processing module. The transceiver module may include a transmitting module and/or a receiving module, the transmitting module is configured to implement a transmitting function, the receiving module is configured to implement a receiving function, and the transceiver module may implement the transmitting function and/or the receiving function.

The communication apparatus 1 may be a terminal device, an apparatus in a terminal device, or an apparatus that can be matched with a terminal device for use. Alternatively, the communication apparatus 1 may be a network-side device, an apparatus in a network-side device, or an apparatus that can be matched with a network-side device for use.

The communication apparatus 1 is a terminal device.

The apparatus includes the transceiver module 11.

The transceiver module 11 is configured for reporting, in response to sending a RA (RA) preamble by using a RA resource associated with a reference signal, RA attempt related information on the reference signal to a network-side devicel, where the reference signal includes an SSB or a CSI-RS.

In some embodiments, the transceiver module 11 is further configured for, in response to successfully sending the RA preamble by using the RA resource associated with the reference signal, reporting the RA attempt related information on the reference signal to the network-side device; or
in response to that sending the RA preamble by using the RA resource associated with the reference signal is unsuccessful due to a listen-before-talk (LBT) failure, reporting the RA attempt related information on the reference signal to the network-side device; or
in response to that sending the RA preamble by using a RA resource associated with any one of a plurality of reference signals is unsuccessful, selecting one or more reference signals from the plurality of reference signals, and reporting the RA attempt related information on the selected one or more reference signals to the network-side device.

In some embodiments, each preamble transmission attempt of RA performed by using a RA resource associated with a reference signal is calculated as one RA attempt on the reference signal, whether LBT succeeds or not, and the RA attempt related information on the reference signal includes information related to each RA attempt on the reference signal.

In some embodiments, the transceiver module 11 is further configured for reporting the RA attempt related information on the reference signal to the network-side device in response to the terminal device being not configured with LBT failure recovery configuration (lbt-FailureRecoveryConfig), reporting the RA attempt related information on the reference signal to the network-side device.

In some embodiments, when unsuccessfully sending the RA preamble by using the RA resource associated with the reference signal due to the LBT failure is counted as one RA attempt on the reference signal, the information related to the one or more RA attempts on the reference signal comprises: information related to that sending the RA preamble by using the RA resource associated with the reference signal is unsuccessful due to the LBT failure.

In some embodiments, the RA attempt related information on the reference signal includes at least one:
a downlink reference signal received power being greater than a threshold dlRSRPAboveThreshold; or
sending the RA preamble being failed due to the LBT failure.

In some embodiments, the RA attempt related information on the reference signal does not include at least one of:

contention detected, contentionDetected; or
fallback to four step RA, fallbackToFourStepRA.

In some embodiments, each attempt of sending the RA preamble by using the RA resource associated with the reference signal is counted as one RA attempt on the reference signal, only when the RA preamble is successfully sent, and the information related to the one or more RA attempts on the reference signal includes RA attempt related information on the reference signal.

In some embodiments, the transceiver module 11 is further configured for reporting the RA attempt related information on the reference signal to the network-side device, in response to the terminal device being configured with lbt-FailureRecoveryConfig.

In some embodiments, the information related to the one or more RA attempts on the reference signal further includes: a number of continuous failures of sending the RA preamble by using the RA resource associated with the reference signal due to LBT failure, before successfully sending the RA preamble by using the RA resource associated with the reference signal.

In some embodiments, the transceiver module 11 is further configured for reporting a RA information list to the network-side device, wherein the RA information list comprises the RA attempt related information on the reference signal.

In some embodiments, the transceiver module 11 is further configured for perform at least one of:
reporting a connection establishment failure report to the network-side device, wherein the connection establishment failure report comprises the RA attempt related information on the reference signal;
reporting a RA report to the network-side device, wherein the RA report comprises the RA attempt related information on the reference signal;
reporting a radio link failure (RLF) report to the network-side device, wherein the RLF report comprises the RA attempt related information on the reference signal;
reporting secondary cell group (SCG) failure information to the network-side device, wherein the SCG failure information comprises the RA attempt related information on the reference signal;
reporting a handover success report to the network-side device, wherein the handover success report comprises the RA attempt related information on the reference signal;
reporting a primary secondary cell (PScell) addition success report to the network-side device, wherein the PScell addition success report comprises the RA attempt related information on the reference signal; or
reporting a PScell change success report to the network-side device, wherein the PScell change success report comprises the RA attempt related information on the reference signal.

The communication apparatus 1 is a network-side device,
where the apparatus includes: a transceiver module 11.

The transceiver module 11 is configured for receiving RA attempt related information on a reference signal reported by a terminal device, wherein the RA attempt related information on the reference signal is reported by the terminal device when sending a preamble by using a RA resource associated with the reference signal, and the reference signal comprises an SSB or a CSI-RS.

In some embodiments, the transceiver module 11 is further configured for receiving RA attempt related information on the reference signal reported by the terminal device, where the RA attempt related information on the reference signal is reported by the terminal device when the terminal device successfully sends the RA preamble by using the RA resource associated with the reference signal; or
receiving the RA attempt related information on the reference signal reported by the terminal device, wherein the RA attempt related information on the reference signal is reported by the terminal device when sending the preamble by using the RA resource associated with the reference signal is unsuccessful due to a listen-before-talk (LBT) failure; or
receiving RA attempt related information on one or more reference signals reported by the terminal device, wherein the information related to the RA attempts on the one or more reference signals is reported by the terminal device by selecting the one or more reference signals from a plurality of reference signals when the terminal device unsuccessfully send the preamble by using a RA resource associated with any one of the plurality of reference signals.

In some embodiments, for each preamble transmission attempt of RA performed by using a RA resource associated with a reference signal, whether LBT succeeds or not is calculated as one RA attempt on the reference signal, and the RA attempt related information on the reference signal includes information related to each RA attempt on the reference signal.

In some embodiments, the transceiver module 11 is further configured for receiving RA attempt related information on the reference signal reported by the terminal device, where the RA attempt related information on the reference signal is reported by the terminal device when the terminal device is not configured with lbt-FailureRecoveryConfig.

In some embodiments, in a case that unsuccessfully sending the RA preamble by using the RA resource associated with the reference signal due to the LBT failure is counted as one RA attempt on the reference signal, the RA attempt related information on the reference signal comprises: information related to that sending the RA preamble by using the RA resource associated with the reference signal is unsuccessful due to the LBT failure.

In some embodiments, the RA attempt related information on the reference signal includes at least one of:
a downlink reference signal received power being greater than a threshold dlRSRPAboveThreshold; or
sending the RA preamble being failed due to the LBT failure.

In some embodiments, the RA attempt related information on the reference signal does not include at least one of:

contention detected, contentionDetected; or
fallback to four step RA, fallbackToFourStepRA.

In some embodiments, each attempt of sending the RA preamble by using the RA resource associated with the reference signal is counted as one RA attempt on the reference signal only when the RA preamble is successfully sent, and the RA attempt related information on the reference signal comprises information related to each RA attempt on the reference signal.

In some embodiments, the transceiver module 11 is further configured for receiving RA attempt related information on a reference signal reported by the terminal device, where the RA attempt related information on the reference signal is reported by the terminal device when being configured with lbt-FailureRecoveryConfig.

In some embodiments, the RA attempt related information on the reference signal further includes: a number of continuous failures of sending the RA preamble by using the RA resource associated with the reference signal due to LBT failure, before successfully sending the RA preamble by using the RA resource associated with the reference signal.

In some embodiments, the transceiver module 11 is further configured for receiving a RA information list reported by the terminal device, where the RA information list includes RA attempt related information on the reference signal.

In some embodiments, the transceiver module 11 is further configured for performing at least one of:
receiving a connection establishment failure report reported by the terminal device, wherein the connection establishment failure report comprises the RA attempt related information on the reference signal;
receiving a RA report reported by the terminal device, wherein the RA report comprises the RA attempt related information on the reference signal;
receiving a radio link failure (RLF), report reported by the terminal device, wherein the RLF report comprises the RA attempt related information on the reference signal;
receiving secondary cell group (SCG), failure information reported by the terminal device, wherein the SCG failure information comprises the RA attempt related information on the reference signal;
receiving a handover success report reported by the terminal device, wherein the handover success report comprises the RA attempt related information on the reference signal;
receiving a primary secondary cell (PScell), addition success report reported by the terminal device, wherein the PScell addition success report comprises the RA attempt related information on the reference signal; or
receiving a PScell change success report reported by the terminal device, wherein the PScell change success report comprises the RA attempt related information on the reference signal.

For the communication apparatus 1 in the foregoing embodiment, a specific manner in which each module performs an operation has been described in detail in the embodiments related to the method, and details are not described herein.

The communication apparatus 1 provided in the foregoing embodiments of the present disclosure obtains the same or similar beneficial effects as the information reporting methods provided in some of the foregoing embodiments, and details are not described herein again.

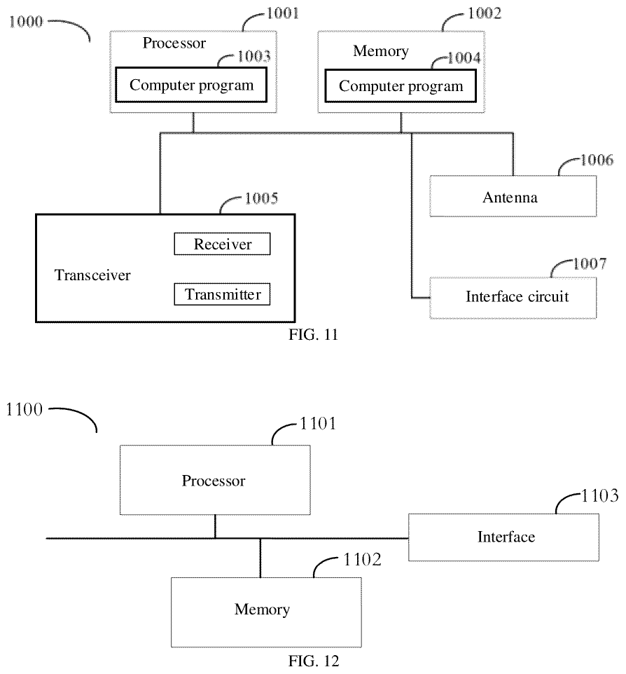

Referring to FIG. 11, FIG. 11 is a schematic structural diagram of a communication apparatus 1000 according to another embodiment of the present disclosure. The communication apparatus 1000 may be a network-side device, a terminal device, a chip, a chip system, or a processor that supports the network-side device in implementing the foregoing methods, or a chip, a chip system, or a processor that supports the terminal device in implementing the foregoing methods. The communication apparatus 1000 is configured to implement the methods described in in the foregoing method embodiments. For details, reference can be made to descriptions in the foregoing method embodiments.

The communication apparatus 1000 may include one or more processors 1001. The processor 1001 may be a general-purpose processor, a special-purpose processor, or the like. For example, it may be a baseband processor or a central processing unit. The baseband processor may be configured to process a communication protocol and communication data, and the central processing unit may be configured to control a communication apparatus (for example, a network-side device, a baseband chip, a terminal device, a terminal device chip, a DU, or a CU), execute a computer program, and process data of the computer program.

In an example, the communication apparatus 1000 may further include one or more memories 1002, where the one or more memories 1002 may store a computer program 1004, and the memory 1002 executes the computer program 1004, so that the communication apparatus 1000 performs the method described in the foregoing method embodiments. In an example, the memory 1002 may further store data. The communication apparatus 1000 and the memory 1002 may be separately disposed, or may be integrated together.

In an example, the communication apparatus 1000 may further include a transceiver 1005 and an antenna 1006. The transceiver 1005 may be referred to as a transceiver unit, a transceiver, a transceiver circuit, or the like, and is configured to implement a transceiver function. The transceiver 1005 may include a receiver and a transmitter, where the receiver may be referred to as a receiver or a receiving circuit, and is configured to implement a receiving function; and the transmitter may be referred to as a transmitter or a sending circuit, and is configured to implement a sending function.

In an example, the communication apparatus 1000 may further include one or more interface circuits 1007. The interface circuit 1007 is configured to receive the code instruction and transmit the code instruction to the processor 1001. The processor 1001 runs the code instructions to cause the communication apparatus 1000 to perform the method described in the foregoing method embodiments.

The communication apparatus 1000 is a terminal device, and the transceiver 1005 is configured to perform S21 in FIG. 2; S31 in FIG. 3; S41 in FIG. 4; S51 in FIG. 5; S61 in FIG. 6; S71 in FIG. 7; S81 in FIG. 9.

The communication apparatus 1000 is a network-side device: the transceiver 1005 is configured to perform S21 in FIG. 2; S31 in FIG. 3; S41 in FIG. 4; S51 in FIG. 5; S61 in FIG. 6; S71 in FIG. 7; S81 in FIG. 9.

In an implementation, the processor 1001 may include a transceiver configured to implement receiving and sending functions. For example, the transceiver may be a transceiver circuit, an interface, or an interface circuit. The transceiver circuit, the interface, or the interface circuit for implementing the receiving and sending functions may be separate or integrated together. The transceiver circuit, the interface, or the interface circuit may be configured to read and write code/data, or the transceiver circuit, the interface, or the interface circuit may be configured to send or transmit a signal.

In an implementation, the processor 1001 may store a computer program 1003, and the computer program 1003 runs on the processor 1001, so that the communication apparatus 1000 can perform the method described in the foregoing method embodiments. The computer program 1003 may be fixed in the processor 1001, and in this case, the processor 1001 may be implemented by hardware.

In an implementation, the communication apparatus 1000 may include a circuit, and the circuit may implement a function of sending, receiving, or communicating in the foregoing method embodiments. The processors and transceivers described in the present disclosure may be implemented on integrated circuits (ICs), analog ICs, radio frequency integrated circuits (RFICs), mixed signal ICs, application specific integrated circuits (ASICs), printed circuit boards (PCBs), electronic devices, and the like. The processor and transceiver may also be fabricated with various IC process technologies, such as complementary metal oxide semiconductor (CMOS), n-type metal oxide semiconductor (NMOS), p-type metal oxide semiconductor (PMOS), bipolar junction transistor (BJT), bipolar CMOS (BiCMOS), silicon germanium (SiGe), gallium arsenide (GaAs), etc.

The communication apparatus described in the above embodiments may be a terminal device or a network-side device, but the scope of the communication apparatus described in the present disclosure is not limited thereto, and the structure of the communication apparatus may not be limited by FIG. 11. The communication apparatus may be a standalone device or may be part of a larger device. For example, the communication apparatus may be:
(1) an independent integrated circuit IC, or chip, or chip system or subsystem;
(2) a set of one or more ICs, for example, the set of ICs may also include a storage component configured to store data and a computer program;
(3) ASIC, such as Modem;
(4) modules that may be embedded within other devices;
(5) a receiver, a terminal device, an intelligent terminal device, a cellular phone, a wireless device, a handset, a mobile unit, an in-vehicle device, a network device, a cloud device, an artificial intelligence device, and the like;
(6) other, etc.

For a case in which the communication apparatus may be a chip or a chip system, reference can be made to FIG. 12, which is a structural diagram of a chip according to an embodiment of the present disclosure.

A chip 1100 includes a processor 1101 and an interface 1103. There may be one or more processors 1101, and there may be a plurality of interfaces 1103.

In a case that the chip is configured to implement functions of the terminal device in the embodiments of the present disclosure:
the interface 1103 is configured to receive a code instruction and transmit the code instruction to the processor.

The processor 1101 is configured to run a code instruction to perform the information reporting method as described in some of the foregoing embodiments.

In a case that the chip is configured to implement functions of the network-side device in the embodiments of the present disclosure:
the interface 1103 is configured to receive a code instruction and transmit the code instruction to the processor.

The processor 1101 is configured to run a code instruction to perform the information reporting method as described in some of the foregoing embodiments.

In an example, the chip 1100 further includes a memory 1102, and the memory 1102 is configured to store a necessary computer program and data.

Those skilled in the art may also understand that various illustrative logical blocks and steps listed in the embodiments of the present disclosure may be implemented by using electronic hardware, computer software, or a combination of the two. Whether such functionality is implemented by hardware or software depends on the particular application and design requirements of the overall system. Those skilled in the art may use various methods to implement the described functions for each specific application, but this implementation should not be understood as being beyond the protection scope of the embodiments of the present disclosure.

An embodiment of the present disclosure further provides an information reporting system, where the system includes the foregoing communication apparatus used as a terminal device and communication apparatus used as a network-side device in the embodiment in FIG. 10, or the system includes the foregoing communication apparatus used as a terminal device and communication apparatus used as a network-side device in the embodiment in FIG. 11.

The present disclosure further provides a readable storage medium having stored thereon instructions that, when executed by a computer, implement functions of any of the above method embodiments.

The present disclosure further provides a computer program product which, when executed by a computer, implements the functions of any one of the above method embodiments.

The above embodiments may be implemented in whole or in part by software, hardware, firmware or any combination thereof. When implemented using software, the embodiments may be implemented in whole or in part in the form of a computer program product. The computer program product includes one or more computer programs. When the computer program is loaded and executed on a computer, the processes or functions according to the embodiments of the present disclosure are all or partially generated. The computer may be a general purpose computer, special purpose computer, computer network, or other programmable device. The computer program may be stored in a computer readable storage medium or transmitted from one computer readable storage medium to another computer readable storage medium. For example, the computer program may be transmitted from one website, computer, server or data center to another website, computer, server or data center in a wired (e.g., coaxial cable, optical fiber, digital subscriber line (DSL)) or wireless (e.g., infrared, wireless, microwave, etc.) manner. The computer-readable storage medium may be any available medium accessible by a computer or a data storage device such as a server or a data center that includes one or more available media. The usable medium may be a magnetic medium (for example, a floppy disk, a hard disk, or a magnetic tape), an optical medium (for example, a high-density digital video disc (DVD)), a semiconductor medium (for example, a solid state disk (SSD)), or the like.

Those of ordinary skill in the art can understand that the numbers of the first, second and other numbers involved in the present disclosure are merely used to distinguish the description, and are not intended to limit the scope of the embodiments of the present disclosure or represent a sequence.

At least one of the present disclosure may also be described as one or more, and a plurality may be two, three, four or more, which is not limited in the present disclosure. In the embodiments of the present disclosure, for a technical feature, technical features in the technical feature are distinguished by “first”, “second”, “third”, “A”, “B”, “C”, and “D”, etc., and the technical features described by “first”, “second”, “third”, “A”, “B”, “C”, and “D” have no order or size order.

The correspondence shown in each table in the present disclosure may be configured or predefined. The value of the information in each table is merely an example, and other values may be configured, which is not limited in the present disclosure. When configuring the correspondence between the information and each parameter, it is not necessary to configure all the correspondences shown in each table. For example, in the table in the present disclosure, the correspondence shown in some rows may not be configured. For another example, appropriate deformation adjustment may be performed based on the foregoing table, for example, splitting or merging. The name of the parameter shown by the title in the foregoing tables may also be another name that can be understood by the communication apparatus, and a value or a representation manner of the parameter may also be another value or a representation manner that can be understood by the communication apparatus. During implementation of the tables, other data structures may also be used, for example, an array, a queue, a container, a stack, a linear table, a pointer, a linked list, a tree, a graph, a structure body, a class, a heap, a hash table, or a hash table may be used.

Predefinitions in the present disclosure may be understood as defining, pre-defining, storing, pre-storing, pre-negotiating, pre-configuring, curing, or pre-firing.

Those of ordinary skill in the art can appreciate that the units and algorithm steps of the examples described in connection with the embodiments disclosed herein can be implemented in electronic hardware, or a combination of computer software and electronic hardware. Whether these functions are performed in hardware or software depends on the specific application and design constraints of the technical solution. A person skilled in the art may implement the described functionality using different methods for each particular application, but such implementations should not be considered beyond the scope of the present disclosure.

A person skilled in the art may clearly understand that, for ease and brevity of description, a specific working process of the foregoing described system, apparatus, and unit may refer to a corresponding process in the foregoing method embodiments, and details are not described herein again.

The above description is merely specific embodiments of the present disclosure, but the protection scope of the present disclosure is not limited thereto, and any person skilled in the art may easily conceive of changes or substitutions within the technical scope of the present disclosure, which shall be covered within the protection scope of the present disclosure. Therefore, the protection scope of the present disclosure shall be controlled by the protection scope of the claims.

1. An information reporting method, performed by a terminal device and comprising:
reporting, in response to sending a random access (RA) preamble by using a RA resource associated with a reference signal, RA attempt related information on the reference signal to a network-side device, wherein the reference signal comprises a synchronization signal block (SSB) or a channel state information reference signal (CSI-RS).

2. The method according to claim 1, wherein the reporting, in response to sending a RA preamble by using a RA resource associated with a reference signal, RA attempt related information on the reference signal to a network-side device, comprises any one of:
in response to successfully sending the RA preamble by using the RA resource associated with the reference signal, reporting the RA attempt related information on the reference signal to the network-side device;
in response to that sending the RA preamble by using the RA resource associated with the reference signal is unsuccessful due to a listen-before-talk (LBT) failure, reporting the RA attempt related information on the reference signal to the network-side device; or
in response to that sending the RA preamble by using a RA resource associated with any one of a plurality of reference signals is unsuccessful, selecting one or more reference signals from the plurality of reference signals, and reporting the RA attempt related information on the selected one or more reference signals to the network-side device.

3. The method according to claim 1, wherein the reporting, in response to sending a RA preamble by using a RA resource associated with a reference signal, RA attempt related information on the reference signal to a network-side device comprises:
in response to sending the RA preamble by using the RA resource associated with the reference signal and the terminal device being not configured with listen-before-talk (LBT) failure recovery configuration (Ibt-FailureRecoveryConfig), reporting the RA attempt related information on the reference signal to the network-side device;
wherein each attempt of sending the RA preamble by using the RA resource associated with the reference signal is counted as one RA attempt on the reference signal, whether LBT succeeds or not, and
the RA attempt related information on the reference signal comprises information related to each RA attempt on the reference signal.

4. (canceled)

5. The method according to claim 3, wherein in a case that unsuccessfully sending the RA preamble by using the RA resource associated with the reference signal due to a LBT failure is counted as one RA attempt on the reference signal, the RA attempt related information on the reference signal comprises: information related to that sending the RA preamble by using the RA resource associated with the reference signal is unsuccessful due to the LBT failure.

6. The method according to claim 5, wherein the RA attempt related information on the reference signal comprises at least one of:
a downlink reference signal received power being greater than a threshold (dIRSRPAboveThreshold); or
sending the RA preamble being failed due to the LBT failure.

7. The method according to claim 5, wherein the RA attempt related information on the reference signal does not comprise at least one of:
contention detected (contentionDetected); or
fallback to four step RA (fallbackToFourStepRA).

8. The method according to claim 1, wherein the reporting, in response to sending a RA preamble by using a RA resource associated with a reference signal, RA attempt related information on the reference signal to a network-side device, comprises:
in response to sending the RA preamble by using the RA resource associated with the reference signal and the terminal device being configured with listen-before-talk (LBT) failure recovery configuration (Ibt-FailureRecoveryConfig), reporting the RA attempt related information on the reference signal to the network-side device;
wherein each attempt of sending the RA preamble by using the RA resource associated with the reference signal is counted as one RA attempt on the reference signal only when the RA preamble is successfully sent, and
the RA attempt related information on the reference signal comprises information related to each RA attempt on the reference signal.

9. (canceled)

10. The method according to claim 8, wherein the RA attempt related information on the reference signal further comprises: a number of continuous failures of sending the RA preamble by using the RA resource associated with the reference signal due to LBT failure, before successfully sending the RA preamble by using the RA resource associated with the reference signal.

11. The method according to claim 1, wherein reporting the RA attempt related information on the reference signal to the network-side device, comprises:
reporting a RA information list to the network-side device, wherein the RA information list comprises the RA attempt related information on the reference signal.

12. The method according to claim 1, wherein reporting the RA attempt related information on the reference signal to the network-side device, comprises at least one of:
reporting a connection establishment failure report to the network-side device, wherein the connection establishment failure report comprises the RA attempt related information on the reference signal;
reporting a RA report to the network-side device, wherein the RA report comprises the RA attempt related information on the reference signal;
reporting a radio link failure (RLF) report to the network-side device, wherein the RLF report comprises the RA attempt related information on the reference signal;
reporting secondary cell group (SCG) failure information to the network-side device, wherein the SCG failure information comprises the RA attempt related information on the reference signal;
reporting a handover success report to the network-side device, wherein the handover success report comprises the RA attempt related information on the reference signal;
reporting a primary secondary cell (PScell) addition success report to the network-side device, wherein the PScell addition success report comprises the RA attempt related information on the reference signal; or
reporting a PScell change success report to the network-side device, wherein the PScell change success report comprises the RA attempt related information on the reference signal.

13. An information reporting method, performed by a network-side device, the method comprising:
receiving random access (RA) attempt related information on a reference signal reported by a terminal device, wherein the RA attempt related information on the reference signal is reported by the terminal device when sending a preamble by using a RA resource associated with the reference signal, and the reference signal comprises a synchronization signal block (SSB), or a channel state information reference signal (CSI-RS).

14. The method according to claim 13, wherein receiving the RA attempt related information on the reference signal reported by the terminal device, comprises:
receiving the RA attempt related information on the reference signal reported by the terminal device, wherein the RA attempt related information on the reference signal is reported by the terminal device when successfully sending the preamble by using the RA resource associated with the reference signal;
receiving the RA attempt related information on the reference signal reported by the terminal device, wherein the RA attempt related information on the reference signal is reported by the terminal device when sending the preamble by using the RA resource associated with the reference signal is unsuccessful due to a listen-before-talk (LBT) failure; or
receiving RA attempt related information on one or more reference signals reported by the terminal device, wherein the RA attempt related information on the one or more reference signals is reported by the terminal device by selecting the one or more reference signals from a plurality of reference signals when sending the preamble by using a RA resource associated with any one of the plurality of reference signals is unsuccessful.

15. The method according to claim 13, wherein the RA attempt related information on the reference signal comprises information related to sending the preamble by using the RA resource associated with the reference signal.

16. The method according to claim 15, wherein receiving the RA attempt related information on the reference signal reported by the terminal device, comprises:
receiving the RA attempt related information on the reference signal reported by the terminal device, wherein the RA attempt related information on the reference signal is reported by the terminal device when the terminal device is not configured with listen-before-talk (LBT) failure recovery configuration (Ibt-FailureRecoveryConfig).

17. The method according to claim 15, wherein the RA attempt related information on the reference signal comprises information related to that sending the preamble by using the RA resource associated with the reference signal is unsuccessful due to a listen-before-talk (LBT) failure.

18. The method according to claim 17, further comprising at least one of:
the RA attempt related information on the reference signal comprising at least one of: a downlink reference signal received power being greater than a threshold (dIRSRPAboveThreshold); or sending the preamble being failed due to the LBT failure; or
the RA attempt related information on the reference signal not comprising at least one of: contention detected (contentionDetected); or fallback to four step RA (fallbackToFourStepRA).

19. (canceled)

20. The method according to claim 13, further comprising at least one of:
the RA attempt related information on the reference signal comprising information related to successfully sending the preamble by using the RA resource associated with the reference signal;
receiving the RA attempt related information on the reference signal reported by the terminal device, comprising: receiving the RA attempt related information on the reference signal reported by the terminal device, wherein the RA attempt related information on the reference signal is reported by the terminal device when being configured with listen-before-talk (LBT) failure recovery configuration (Ibt-FailureRecoveryConfig); or
the RA attempt related information on the reference signal further comprising: a number of continuous failures of sending the preamble by using the RA resource associated with the reference signal due to LBT failure, before successfully sending the preamble by using the RA resource associated with the reference signal.

21. (canceled)

22. (canceled)

23. The method according to claim 13, wherein receiving the RA attempt related information on the reference signal reported by the terminal device, comprises:
receiving a RA information list reported by the terminal device, wherein the RA information list comprises the RA attempt related information on the reference signal.

24. The method according to claim 13, wherein receiving the RA attempt related information on the reference signal reported by the terminal device, comprises at least one of:
receiving a connection establishment failure report reported by the terminal device, wherein the connection establishment failure report comprises the RA attempt related information on the reference signal;
receiving a RA report reported by the terminal device, wherein the RA report comprises the RA attempt related information on the reference signal;
receiving a radio link failure (RLF) report reported by the terminal device, wherein the RLF report comprises the RA attempt related information on the reference signal;
receiving secondary cell group (SCG) failure information reported by the terminal device, wherein the SCG failure information comprises the RA attempt related information on the reference signal;
receiving a handover success report reported by the terminal device, wherein the handover success report comprises the RA attempt related information on the reference signal;
receiving a primary secondary cell (PScell) addition success report reported by the terminal device, wherein the PScell addition success report comprises the RA attempt related information on the reference signal; or
receiving a PScell change success report reported by the terminal device, wherein the PScell change success report comprises the RA attempt related information on the reference signal.

25. (canceled)

26. (canceled)

27. A communication apparatus, comprising:
a processor; and
a memory storing a computer program executable by the processor;
wherein the processor is configured to: report, in response to sending a random access (RA) preamble by using a RA resource associated with a reference signal, RA attempt related information on the reference signal to a network-side device, wherein the reference signal comprises a synchronization signal block (SSB) or a channel state information reference signal (CSI-RS); or
wherein the processor is configured to: receive RA attempt related information on a reference signal reported by a terminal device, wherein the RA attempt related information on the reference signal is reported by the terminal device when sending a preamble by using a RA resource associated with the reference signal, and the reference signal comprises a SSB, or a CSI-RS.

28. (canceled)

29. (canceled)
